(19) United States
(12) Patent Application Publication
(10) Pub. No.: US 2026/0347277 A1
(43) Pub. Date: Nov. 5, 2026

(54) IMPROVED GRANULATION PROCESS AND GRANULE

(71) Applicants: Casale SA, Lugano (CH); UNIVERSITA' DEGLISTUDI DIP PADOVA, Legnaro (PD) (IT)

(72) Inventors: Leonardo Marrone, Mercallo (VA) (IT); Alberto Benedetti, Como (IT); Cristina Pizzolitto, Zoppola (PN) (IT); Maurizio Borin, Legnaro (PD) (IT); Carmelo Maucieri, Legnaro (PD) (IT); Giorgia Raimondi, Legnaro (PD) (IT); Giancarlo Renella, Legnaro (PD) (IT)

(73) Assignee: Casale SA, Lugano (CH)

(21) Appl. No.: 19/152,763

(22) PCT Filed: Feb. 2, 2024
(86) PCT No.: PCT/EP2024/052606

§ 371 Date: Jul. 31, 2025

(30) Foreign Application Priority Data
Feb. 3, 2023 (EP) 23154996.5

(51) Int. Cl. C05G 5/12; C05C 9/02

(52) U.S. Cl. CPC C05G 5/12; C05C 9/02

(57) ABSTRACT

A process of granulation of urea and relative granules wherein urea granules are produced from a urea melt, wherein at least one additive including gallic acid and/or methylthioninium chloride is/are used in the granulation process.

### FIELD OF THE INVENTION

The present invention relates to a process of granulation of urea and granules of urea obtainable with said process.

### PRIOR ART

The current agricultural system is facing the challenge of feeding the increasing world population and mitigating environmental impact. The current world population is over 8 billion and is expected to reach about 10 billion in 2050. The land available for food production is limited and plants have a critical nutrient uptake limit. For the above reasons, there is a strong incentive to increase yield per unit and optimize resources.

Fertilization has a basic role in crop production and notably affects its environmental impact, particularly soil nitrogen (N) dynamics. Furthermore, agriculture represents a significant source of human-made emissions of N2O due to fertilization.

Urea is the most common source of nitrogen for fertilization. Granules of solid urea for use as fertilizer (so called agricultural urea) are typically produced by means of a granulation process. The granulation process is described in the literature of urea production, for example Ullmann's encyclopaedia of industrial chemistry.

In summary, the known urea processes such as CO₂ stripping or self-stripping, produce an aqueous urea solution having a concentration of around 65-70%. This solution is treated to remove water in a suitable evaporation section, to obtain a urea melt with a concentration suitable for the urea granulation, which is typically 96% of higher (by weight). The granulation process is performed in a granulation apparatus, where the urea melt is sprayed and solidifies over the granules until a target size of the granules is reached. The process is also fed with small particles of solid urea called seeds, which act as starting nuclei for the granulation process. Said seeds may be separately prepared or obtained by crushing a portion of the granules, for example a portion which does not meet size specification. The granulation process is preferably performed in a fluid-bed condition. The granulation process may include the use of additives, the most common being formaldehyde which is an anti-caking agent and increases the mechanical properties, such as crushing strength, of the granules.

Another well-known process for producing solid urea is the prilling process, which is also described in the literature.

Granulation of urea and related equipment are disclosed among others in EP 2 077 147, which discloses a process where a portion of the growth liquid is used to produce directly the seed material, and WO 2012/113473 which discloses a granulation process with additives. EP 1 935 482 describes a fluid-bed granulation process wherein the fluid bed is maintained in a vortex condition. The granulation process and the prilling process are also described in the urea literature, for example in the Ullmann's Encyclopedia.

During its use as fertilizer, urea easily undergoes transformation processes such as hydrolysis (i.e. urease) and nitrification. If these processes are necessary to sustain plant nutrition, they may also harm the environment by release of ammonia (NH₃) into the atmosphere and contamination of groundwater through NO₃ leaching after nitrification. Therefore, the nitrogen use efficiency (NUE) is among the most critical research issues. Alongside the input of nitrogen, the overall crop nutrition should be improved.

In this context, a wide range of new fertilizers is being developed to adjust nutrients release to plant requirements and increase nutrients efficiency. Nutrient uptake by crops usually follows a sigmoidal graphical pattern, which is synchronized with crop phenology such as germination, shoot formation, flowering, grain filling, and fruit formation. An ideal nutrient release should fully match that sigmoidal pattern to minimize losses.

Fertilizers able to adapt the timing of nutrient release to the plant nutrient demand, are generally referred to as “smart fertilizers” and are classified based on their operational mechanism. Among the different mechanisms adopted to improve the nitrogen use efficiency, the inhibition of the urease reaction as well as inhibition of the nitrification process are amongst the most effective. Slowing down the nitrification process reduces the nitrogen loss by leaching and denitrification while slowing down the urease process reduces the nitrogen loss by ammonia volatilization.

In the current art, N-(n-Butyl) thiophosphoric triamide (NBPT) is used as urease inhibitor. Parallelly, Dicyandiamide (DCD) is a consolidated nitrification inhibitor. The above chemicals are normally dissolved in a solvent and the so obtained solution is sprayed onto finished urea granules or prills downstream the granulation or prilling section.

However, the usage of the above-mentioned additives poses a series of health and safety issues. The solvents used are volatile and therefore difficult to recover once evaporated. NBPT is toxic and harmful to the aquatic environment and DCD is also toxic to the aquatic environment.

U.S. Pat. No. 8,343,891 discloses a method of improving the properties of urea granules, by the addition of an additive to the urea.

### SUMMARY OF THE INVENTION

The invention aims to a new urea-based fertilizer and a related process of production to overcome the above-mentioned issues in connection with the use of NBPT and/or DCD as additives. A further aim of the invention is to provide an environmentally acceptable alternative to the above-mentioned additives used in the production of urea granules.

The above aims are reached with a urea granulation process according to the claims. According to the invention gallic acid is used as urease inhibitor and/or methylthioninium chloride, known as methylene blue, is used as nitrification inhibitor. The invention provides that one or both of said additives is added directly in the granulation process. Consequently, the so obtained urea granules are not simply coated with the additive, rather the additive is contained in the urea granules according to a desired distribution.

According to some embodiments, at least one of said additives is added to selected steps of the granulation process. Consequently, the additive can be concentrated in a selected region of the granules, for example in a layer of the granules. In some embodiments the process results in the additive being predominantly or exclusively contained in a layer of the granules. In certain embodiments, the process results in granules with a layered structure including a layer containing most or all of the methylene blue and a layer containing the most or all of the gallic acid. In embodiments where both additives are used, the gallic acid is preferably added after the methylene blue, within the granulation process, so that the gallic acid is contained in an outer layer and the methylene blue is contained in an inner layer of the granules.

A further aspect of the invention is a urea granulate comprising at least one of methylthioninium chloride and gallic acid according to the claims.

### DESCRIPTION OF THE INVENTION

The gallic acid is added to the granulation process preferably in an amount so that the total content of gallic acid in the urea granules, obtained after the granulation process, is in the range 0.2 g/kg to 10 g/kg, preferably 0.5 to 5.0 g/kg and more preferably 1.0 to 3.0 g/kg.

The methylthioninium chloride (methylene blue) is added to the granulation process preferably in an amount so that its total content in the urea granules, obtained after the granulation process, is in the range 0.12 g/kg to 10 g/kg, preferably 0.5 to 5.0 g/kg and more preferably 0.8 to 1.5 g/kg.

The above ranges shall be understood as grams of the additive per kg of granulated urea.

The granulation process can be performed in a granulation apparatus, wherein a feed of urea melt is sprayed in the granulation apparatus and the apparatus is fed with solid particles of urea, called seeds, suitable to act as starting nuclei for the granulation process.

According to different embodiments, some or all of said granulation seeds are obtained by crushing a portion of the granules obtained after the granulation process; in addition or alternatively, some or all of said granulation seeds can be separately prepared with a portion of said urea melt.

The crushed portion of granules may include undersize and oversize granules, separated by passing the product of the granulation apparatus (urea granules) through suitable screeners.

The separate production of granulation seeds is made preferably by rotoforming, wherein droplets of urea melt are deposited on a cooled belt. Alternatively, granulation seeds may be produced by a separate prilling or granulation process. For example, a small portion of the available urea melt can be sent to a prilling equipment or to a separate granulator for the production of the seeds.

In a preferred embodiment, all granulation seeds are produced separately with a portion of the urea melt and no recycle of the product by crushing granules and reintroducing them in the granulator, is performed. This once-through embodiment may be preferable to provide accurate control of the amount of additive in different layers of the granules.

The granulation process is preferably a fluid-bed process, wherein the urea granules are maintained in a fluidized condition by means of a suitable fluidizing medium, which is typically air. In preferred embodiments, the granules are maintained in a vortex or double-vortex condition.

The granulation process may include a sequence of granulation stages from a first granulation stage to a last granulation stage, wherein at each granulation stage a feed of urea melt is introduced into the granulation apparatus by means of one or more sprayers. For example, at each granulation stage an amount of the urea feed is introduced by a set of sprayers arranged around the granulation apparatus. The sprayers of different granulation stages may be fed by a urea melt header.

In a highly preferred embodiment, one or more initial granulation stages are performed without the addition of any of said gallic acid and methylthioninium chloride, and at least one of said gallic acid and methylthioninium chloride is added to one or more subsequent granulation stages. Accordingly, granules can be obtained wherein the core of the granules contains no or substantially no amount of the above-mentioned additives, which are predominantly or exclusively concentrated in a selected layer. For example, in embodiments where both additives are used, it is preferred that methylene blue is added to a first set of granulation stages and gallic acid is added to a subsequent second set of granulation stages, so that granules are obtained with a core substantially free of said additives; an inner layer containing the methylene blue; an outer layer containing the gallic acid.

A layered structure of the urea granules is advantageous because a desired release of nutrients is achieved and meanwhile urease and the nitrification reaction are prevented.

In an interesting embodiment, after the initial granulation stages performed without said additives, the methylthioninium chloride is added to a first sequence of one or more granulation stages, and the gallic acid is added to a second sequence of one or more granulation stages, wherein the stages of the second sequence are performed after and downstream the stages of the first sequence, wherein methylthioninium chloride is not added to the steps of the second sequence, and gallic acid is not added to the steps of the first sequence.

The methylthioninium chloride and/or gallic acid can be introduced directly in the granulation apparatus or added to a urea melt stream before said stream is introduced in the granulation apparatus. Adding said additives to one or more urea melt stream(s) is a preferred embodiment.

According to a preferred embodiment, each of the above-mentioned additives may be added to a urea melt header which feeds different stages of granulation, or to an individual set of sprayers which introduce the urea melt into a single stage of granulation.

To prevent thermal deterioration of gallic acid it is advantageous to minimize a residence time from the injection point into a molten urea stream to the introduction into the granulation apparatus. Said residence time is preferably not greater than 30 s, preferably not greater than 15 s and most preferably not greater than 10 s.

According to a preferred embodiment, the methylthioninium chloride and/or gallic acid is introduced in the granulation process so that the methylthioninium chloride or gallic acid is added to a layer of the urea granules, said layer having a volume which is 0.2 to 0.4 the total volume of the urea granule, preferably 0.3 or around 0.3. The total volume of the urea granules is understood as the volume of the granule including the above-mentioned layer containing the methylthioninium chloride or gallic acid, and any coating layer.

Preferably the process is controlled so that the urea granules exiting the granulate apparatus have a spherical shape.

Preferably, the urea granules have an average diameter which is in the range of 2.8 mm to 3.5 mm, preferably 2.9 mm to 3.1 mm. or more preferably of 3.0 mm or about 3.0 mm. Said average diameter refers to the granules including any additive-containing layer and coating layer.

Preferably the urea melt has a content of urea of at least 96% by weight and the nitrogen content in the urea granules is at least 46% by weight.

In some embodiments, the process may further comprise the steps of adding a further additive such as formaldehyde or a formaldehyde-containing additive in the granulation apparatus to improve the mechanical strength of the granules.

Each of the additives gallic acid and methylene blue, prior to being injected into the granulator apparatus or into a urea melt stream, is preferably mixed with an aqueous solution of urea to form an aqueous dispersion. Preferably the concentration of the additive in the aqueous urea dispersion is selected in order to minimize the water input to the urea melt and avoid the precipitation of urea from the dispersion especially when the dispersion is stored at a relatively low temperature.

In a particularly interesting embodiment, the above-mentioned aqueous urea solution, which is mixed with the gallic acid or with the methylene blue to form the dispersion, has a urea concentration in the range of 40% to 80% by weight.

According to a preferred embodiment of the invention, the gallic acid and said methylthioninium chloride are introduced in the granulation process in the form of a dispersion in an aqueous urea solution.

Preferably methylthioninium chloride is dispersed in said aqueous solution in a concentration of 15% to 30%.

Preferably said gallic acid is dispersed in said aqueous solution of urea in a concentration of 20% to 35%.

A further aspect of the invention is a urea granulate comprising methylthioninium chloride and/or gallic acid added as additive in the granulate.

Preferably, the methylthioninium chloride is in an amount of 0.12 to 10 grams of methylthioninium chloride per kg of urea granule, more preferably 0.5 to 5.0 g/kg and particularly preferably 0.8 to 1.5 g/kg.

Preferably, the gallic acid is in an amount of 0.2 to 10 grams of gallic acid per kg of urea granule, more preferably 0.5 to 5.0 g/kg and particularly preferably 1.0 to 3.0 g/kg.

In a preferred embodiment, the urea granulate consists of a multi-layered structure comprising a nucleus of urea, a first layer of methylthioninium chloride mixed with urea and a second layer of gallic acid mixed with urea. The first layer of the granule surrounds the nucleus and the second layer surrounds the first layer.

In an interesting embodiment, said nucleus of the granulate is free of additive; accordingly, methylthioninium chloride and gallic acid are only added in the layers surrounding the nucleus.

According to a preferred embodiment, the urea granulate is spherical and the average diameter of the granulate is between 2.8 and 3.5 mm, preferably 2.9 mm to 3.1 mm and more preferably is 3.0 mm or about 3.0 mm. Preferably, at least 90% by mass of the granular urea has a diameter in the range 2.0 to 4.0 mm.

### DESCRIPTION OF THE FIGURES

FIG. 1 is a diagram of a urea granulation process according to an embodiment of the invention, wherein the granulation process is a once-through process.

FIG. 2 is a diagram of a urea granulation process according to an embodiment of the invention wherein part of the urea granules is recycled into the granulation apparatus.

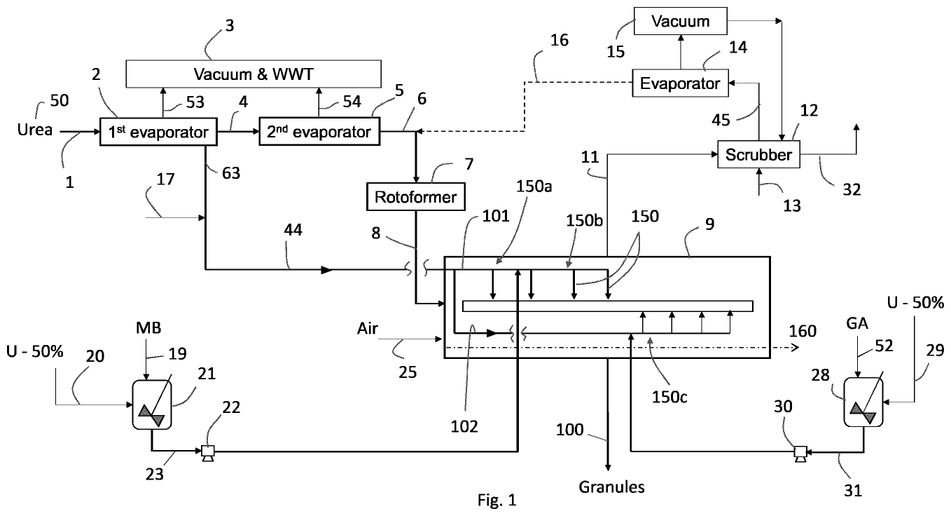

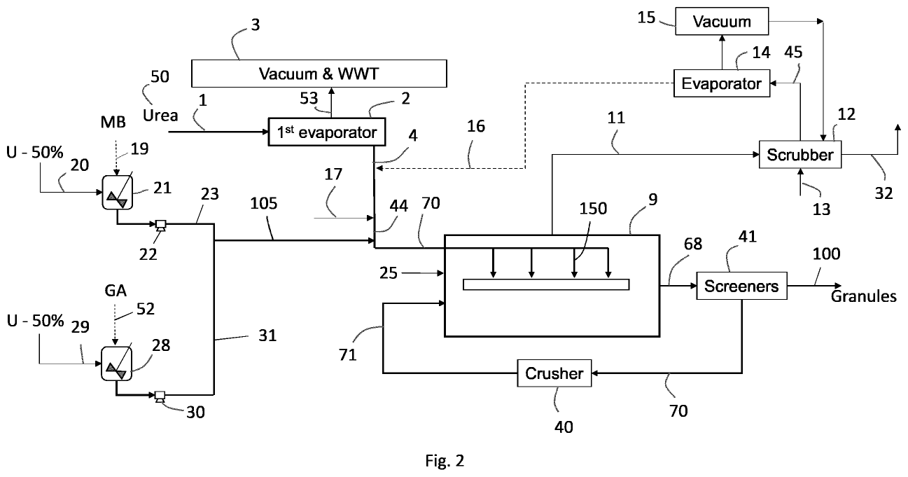

FIGS. 1 and 2 disclose the following main items:
Evaporators 2, 5, 14
Vacuum and waste water treatment section (WWT) 3
Granulator 9
Rotoformer 7
Scrubber 12
Mixing tanks 21, 28
Vacuum unit 15
Crusher 40 (FIG. 2)
Screeners 41 (FIG. 2).

FIG. 1 shows a process for generating urea granules 100 containing methylthioninium chloride and gallic acid as additives. The process works as follow.

An aqueous solution of urea 50 is fed via line 1 to a first evaporator 2 to generate a more concentrated urea solution or urea melt; a first portion of the concentrated urea solution is sent via line 63 to the granulator 9; a second and minor portion of the concentrated urea solution is sent via line 4 to a second evaporator 5 for further concentration, to produce a highly concentrated urea melt 6 which feeds a seeds producer such as the rotoformer 7. The water 53, 54 removed by the evaporators 2 and 5 is processed in the waste water treatment section 3.

The first portion of urea solution 63 is added with formaldehyde or with a formaldehyde-containing additive 17 to generate a formaldehyde-containing urea melt 44 supplied to the urea granulator 9.

The highly concentrated urea melt 6 is used in the rotoformer 7 to generate granulation seeds 8 of solid urea. The seeds 8 are then fed to the granulator 9 to be used as precursors for the growth of the granules 100. In the example, said urea melt 6 is added with a recycle stream 16 obtained from the processing of the granulation offgas 11.

In addition to the seeds 8 and the urea melt 44, the granulator 9 receives a urea solution 23 containing methylene blue and a urea solution 31 containing gallic acid. Said solutions 23, 31 are preferably a dispersion of the additive in a urea solution of a suitable concentration, as explained below.

The granulator 9 in the depicted embodiment is a fluidized bed apparatus wherein a fluid-bed condition of the urea granules is maintained by fluidizing air 25. The granulator 9 has a longitudinal direction 160 and is provided with multiple injection nozzles (or sprayers) 150 arranged lengthwise and located at multiple granulation stages of the apparatus.

In particular, FIG. 1 shows a first granulation stage 150a, a second granulation stage 150b and a third granulation stage 150c in sequence. Each granulation stage may include one or more nozzles 150. FIG. 1 is for illustrative purpose and the actual number of granulation stages may vary, in particular it may be greater.

The first granulation stage 150a is fed with the urea melt 44, which is introduced into the granulator 9 by means of the nozzles 150 located at said first stage 150a; the second granulation stage 150b is fed with the urea melt 44 added with the methylthioninium chloride dispersion 23, being downstream the injection point of the dispersion 23; the third granulation stage 150c is fed with the urea melt 44 added with the gallic acid dispersion 31. Having a separate urea melt header 102, the third granulation stage does not receive the methylene blue dispersion 23.

In more details, FIG. 1 shows that a main header carrying the urea melt 44 is separated into a first header 101 carrying a first portion of the urea melt and a second header 102 carrying a second portion of the urea melt. The first header 101 feeds the nozzles of the first stage 150a and of the second stage 150b, and the second header 102 feeds separately the nozzles of the third stage 150c.

The first granulation stage 150a receives the urea melt 44 as in the main header, added with the formaldehyde additive 17. The second granulation stage 105b receives the urea melt 44 further added with the methylthioninium chloride dispersion 23. The third granulation stage 150c, being fed by the second header 102, receives the urea melt 44 further added with the gallic acid dispersion 31. At each stage, the urea melt is introduced in the granulator 9 via the sprayers 150.

The depicted configuration of the granulator 9 is particularly advantageously because it allows to form granules 100 having a core of urea containing formaldehyde (obtained by the spraying of the urea melt 44) surrounded by a first layer of urea containing methylthioninium chloride, formed in the second stage 150b due to the injection of the urea melt mixed with the dispersion 23, and further surrounded by a second layer of urea containing gallic acid, formed in the third stage 150c after injection of the urea melt mixed with the dispersion 31.

In the example, the formaldehyde initially added to the urea melt 63 is present in all layers of the granules.

The methylthioninium chloride and the gallic acid dispersions 23, 31 are obtained as follows.

Methylthioninium chloride denoted as MB is added vie line 19 to a stirred mixing tank 21 together with aqueous urea solution 20 to generate the dispersion 23. Similarly, gallic acid GA is added via line 52 to a stirred mixing tank 28 together with aqueous urea solution 29 to generate the dispersion 31. The urea solution 20 and the urea solution 29 preferably contain 50% urea by weight. The dispersions 23, 31 are fed to the respective granulation stages 150b, 150c by pumps 22, 30.

The granulator 9 of FIG. 1 is operated according to a once-through process wherein all the urea seeds 8 are obtained by converting the highly concentrated urea solution 6 into small granules or pastilles of solid urea and no seed material is obtained by recycling output granules into the process.

A byproduct offgas 11 is removed from the granulator 9. The offgas 11 may contain fluidizing air, urea dust and small amounts of the additives used in the granulation process. The offgas 11 is purified in the scrubber 12 using a scrubbing medium such as water 13. Outputs of the scrubber 12 are an aqueous solution of urea 45 and a purified gas 32 which is vented into the atmosphere.

The aqueous solution 45 is concentrated in the evaporator 14 coupled to a vacuum unit 15 to generate the recovery urea stream 16 which is mixed with the highly concentrated urea melt 6 to produce the input for the rotoformer 7.

FIG. 2 shows a granulation process which differs from the process of FIG. 1 in that the granulation seeds are obtained by crushing a portion of the product, instead of being prepared separately from a portion of the urea melt, and in that methylene blue and gallic acid are added together in a mixed dispersion 105.

In FIG. 2, the granules 68 obtained in the granulator 9 are subjected to a screening step in the screeners 41 to separate undersized or oversized granules 70 which are crushed in the crusher 40 to form seeds 71. The granules which meet size specifications and are not discarded by the screeners 41 form the granular product 100.

The granules 100 have a uniform or nearly uniform distribution of additives within the granules, as a consequence of the additives being added with the same dispersion 105.

The urea melt 50 is fed via line 1 to an evaporator 2 to remove water 53 and generate a concentrated urea melt 4. The concentrated urea melt 4 is added with recycle stream 16 and formaldehyde-containing additive 17 to generate the urea melt 44.

The methylthioninium chloride dispersion 23 and the gallic acid dispersion 31 are obtained following the same procedural steps as above described in connection with the embodiment of FIG. 1. The methylthioninium chloride dispersion 23 and the gallic acid dispersion 31 are then mixed to form the mixed dispersion 105 which is added to the urea melt 44. The so obtained urea melt feed is supplied to all stages of the granulator 9 via a common header 70 with feeds all the urea sprayers 150.

The processing of the offgas 11 is equivalent to what described above in connection with the embodiment of FIG. 1.

### Example 1

In the process of FIG. 1, 60′200 kg/h of urea solution 50 are sent to the first evaporator 2 to generate 41′570 kg/h (97% w) of urea melt 63. Said urea melt 63 is mixed with 209 kg/h of formaldehyde-containing additive 17 to generate the urea melt 44 supplied to the urea granulator 9.

The highly concentrated melt 6 from the second evaporator 5 is mixed with 1′306 kg/h of recycled urea melt 16 to generate 2′446 kg/h of highly concentrated urea melt (99.7% w) which feeds the rotoformer 7. The rotoformer 7 produces granulation seeds 8 having a diameter of 1.20 mm.

52 kg/h of methylthioninium chloride are added to the mixing tank 21 together with 252 kg/h of urea solution (50% w) to generate 304 kg/h (16.7% w) of the methylthioninium chloride dispersion 23.

Similarly, 89 kg/h of gallic acid are added to the mixing tank 28 together with 214 kg/h of urea solution (50% w) to generate 306 kg/h (29.0% w) of the gallic acid dispersion 31.

The granules 100 are spherical granules having a diameter d=3.05 mm and containing 46.2% by weight of nitrogen. The offgas 11 removed from the granulator 9 contains urea dust equivalent to around 3% of the sprayed urea melt.

The offgas 11 is treated in the scrubber 12 to generate 3′255 kg/h of an aqueous solution of urea 45 (40% w) which is then evaporated in the evaporator 14 to generate the recycle urea melt 16.

### Example 2

In the process of FIG. 2, 60′200 kg/h of urea melt 50 are fed via line 1 to the first evaporator 2; the urea melt produced in the evaporator 2 receives 1′328 kg/h of urea melt 16 from the evaporator 14 to generate 44′080 kg/h of urea melt 4 at 97% w. The urea melt 4 is added with 209 kg/h of the formaldehyde-containing additive 17.

52 kg/h of methylthioninium chloride are added to the mixing tank 21 together with 252 kg/h of urea solution (50% w) to generate 304 kg/h (16.7% w) of methylthioninium chloride dispersion 23.

89 kg/h of gallic acid are added to the mixing tank 28 together with 214 kg/h of urea solution (50% w) to generate 306 kg/h (29.0% w) of gallic acid dispersion 31.

The methylthioninium chloride dispersion 23 is then mixed with the gallic acid dispersion 31 to generate 610 kg/h of the urea melt feed 105.

Roughly 50% of the granules 68 entering the screeners 41 are recycled back to the granulator after crushing.

The scrubber 12 produces 3′255 kg/h of aqueous solution of urea 45 (40% w) which is evaporated in the evaporator 14 to generate the recycle urea melt 16.

### Experimental Results

Several field trials 1 to 3 were carried out to establish the performance of the granules of the invention as a fertilizer. The field trials were conducted on three types of crops consisting of maize, wheat and hemp. All the field trails were conducted at the University of Padova experimental farm “L. Toniolo” located in Italy. The experiments tests are hereinbelow discussed in details, the following nomenclatures is used for the discussion of the results.
U: indicates a conventional urea fertilizer with no addition of inhibitors or additives;
C: indicates a control ground, no granules were added;
NBPT: indicates a urea granule added with NBPT;
O-GA: indicates a urea granule having a urea core and a single layer of gallic acid GA (with a concentration of 6.3 g/kg in said layer) surrounding the core;
O-BM: indicates a urea granule having a urea core and a layer of methylene blue BM (with a concentration of 3.6 g/kg in the layer) surrounding the core;
O-BMGA: indicates a urea granule having a urea core, an inner layer of methylene blue layer BM (3.6 g/kg) surrounding the core and an outer layer of gallic acid layer GA (6.3 g/kg) surrounding said inner layer.

In the experimental field trials, when the conventional urea granules U were used as fertilizers, two fertilization treatments were carried out over the growing cycle of the crop, both after stem elongation. On the contrary, when the urea granules containing additives were used only a single fertilization treatment was performed. These fertilization treatments were performed before sowing. At the harvest time, the grain and its nitrogen content were quantified. All doses (kgN/ha, kg of Nitrogen per hectare) reported in the following field trials reports have to be intended as total amount of fertilizer applied over the entire agricultural cycle of the crop

### Field Trail 1—Maize

The first field trail was carried out on maize. Each fertilization treatment was carried out at a dose of 150 kgN/ha (kilograms of nitrogen per hectare) and each treatment was replicated four times.

The experimental results are presented in terms of plant dry biomass growth [t/ha, tons per hectare] and nitrogen uptake [kg/ha] in some cases, also the NUE %=Nᵤₚₜₐₖₑ/N_{supply} was estimated. The NUE denotes the ratio between the uptake of nitrogen and the supply of nitrogen. The results of the best fertilization treatments compared to conventional urea and the control plot are given in the following table 1.

TABLE 1

| | C | U | NBPT | O-GA | O-BMGA |
|---|---|---|---|---|---|
| Plant dry biomass [t/ha] | 15.7 | 15.6 | 18 | 18.4 | 18.1 |
| Nitrogen uptake [kg/ha] | 179 | 197 | 243 | 230 | 224 |

Table 1 shows that the highest growth (t/ha) was obtained for the O-GA granule. Roughly a +15% of dry biomass increase was observed for the O-GA granule compared to the conventional urea. Table 1 shows that the nitrogen uptake of the plant is roughly equivalent between the different treatments.

### Filed Trail 2—Wheat

The second field trail was carried out on wheat. In the present field trial, different dosage regimes (100, 150 and 200 kg N/ha) were explored for each fertilization treatment. The experimental results of the best fertilization treatments at each dose compared to conventional urea and the control plot are reported in table 2.

TABLE 2

| | C | U | O-GA | U | O-GA | U | O-BMGA |
|---|---|---|---|---|---|---|---|
| Grain [t/ha] | 4.3 | 4.8 | 5.7 | 5.1 | 5.8 | 5.4 | 6.2 |
| Nitrogen dose [kg/ha] | 0 | 100 | 100 | 150 | 150 | 200 | 200 |
| N-uptake [kg/ha] | 75.3 | 81.1 | 95.1 | 96.3 | 108.3 | 106.3 | 107.3 |
| NUE % = Nᵤₚₜₐₖₑ/N_{supply} | — | 81% | 95.1% | 64% | 72% | 53% | 53.6% |

Table 2 shows that with a dosage≤150 kg N/ha the best performance was achieved by the GA granule.

Compared to the conventional urea granule U an increase of +15% of agronomic yield was measured. At higher dose=>200 kg N/ha the O-BMGA granule outperforms the others. Still a +15% of agronomic yield compared to conventional urea was calculated.

### Filed Trail 3—Hemp

The third field trail was carried out on hemp. In particular, Futura 75 which is a monoecious variety of Cannabis sativa was used for the trail. Different dosage regimes (50, 100 and 150 kg N/ha) were investigated. The dosage at which the fertilization treatment has returned the best performance is reported in table 3.

TABLE 3

| | C | U1 | U | NBPT | O-GA | O-BM | O-BMGA |
|---|---|---|---|---|---|---|---|
| Hempseeds [t/ha] | 0.78 | 0.85 | 0.87 | 1.0 | 0.92 | 0.97 | 1.07 |
| Biomass [t/ha] | 11.0 | 11.5 | 12.6 | 13.5 | 11.7 | 13.4 | 13.6 |
| Nitrogen dose [kg/ha] | 0 | 50 | 50 | 100 | 150 | 100 | 150 |

The highest yield was achieved at a dose of 150 kgN/ha. About +20% of agronomic yield was measured compared to conventional urea U granules and +7% compared to NBPT granules. At a dose of 100 kg/ha the BM granule returns the best performance. About +11% of agronomic yield compared to conventional urea granulate U was measured and a reduction of −3% was estimated compared to NBPT granule. The fertilization treatment U1 refers to conventional urea applied only once over the agricultural cycle of the crop

In summary, the following improvements were observed: for maize a +15% dry biomass increase versus conventional urea U granules was observed; for wheat a +15% yield increase versus conventional urea U was observed.

1. A process of granulation of urea wherein urea granules are produced from a urea melt, wherein at least one of gallic acid (GA) and methylthioninium chloride (MB) is used as additive in the granulation process;
wherein said GA and/or MB are introduced directly in a granulation apparatus or added to one or more urea melt stream(s) before said urea melt stream(s) is/are introduced in the granulation apparatus.

2. The process according to claim 1 wherein:
gallic acid is added to the granulation process in an amount so that its total content in the urea granules, obtained after the granulation process, is in the range 0.2 to 10 grams of gallic acid per kg of urea granules, preferably 0.5 to 5.0 g/kg and more preferably 1.0 to 3.0 g/kg, and/or
methylthioninium chloride is added to the granulation process in an amount so that its total content in the urea granules, obtained after the granulation process, is in the range 0.12 to 10 grams of methylthioninium chloride per kg of urea granules, preferably 0.5 to 5.0 g/kg and more preferably 0.8 to 1.5 g/kg.

3. The process according to claim 1, wherein the granulation process is performed in said granulation apparatus, wherein the granulation process includes that urea melt is sprayed in the granulation apparatus and the apparatus is fed with solid seeds to act as starting nuclei for the granulation process, wherein said seeds are obtained by crushing a portion of the granules obtained after the granulation process, or said seeds are separately prepared with a portion of said urea melt.

4. The process according to claim 1, wherein the granulation process is performed in a fluid-bed condition.

5. The process according to any of the previous claim 1 including a sequence of granulation stages from a first granulation stage to a last granulation stage, wherein at each granulation stage a feed of urea melt is introduced into the granulation apparatus by means of one or more sprayers, wherein one or more initial granulation stages are performed without the addition of said gallic acid and methylthioninium chloride, and at least one of said gallic acid and methylthioninium chloride is added to one or more subsequent granulation stages.

6. The process according to claim 5 wherein, after the initial stages performed without said additives, the methylthioninium chloride is added to a first sequence of one or more granulation stages, and the gallic acid is added to a second sequence of one or more granulation stages, wherein the stages of the second sequence are performed after and downstream the stages of the first sequence, wherein methylthioninium chloride is not added to the steps of the second sequence, and gallic acid is not added to the steps of the first sequence.

7. The process according to claim 1, wherein each of the methylthioninium chloride and/or gallic acid is introduced in the granulation process so that the methylthioninium chloride or gallic acid is added to a layer of the urea granules, said layer having a volume which is 0.2 to 0.4 the total volume of the urea granule including any coating layer, preferably 0.3 or around 0.3.

8. The process according to claim 1, wherein the process is controlled so that the urea granules have a spherical shape and the urea granules, including any coating layer, have an average diameter in the range of 2.8 mm to 3.5 mm, preferably 2.9 mm to 3.1 mm.

9. The process according to claim 1, wherein the urea melt has a content of urea of at least 96% by weight.

10. The process according to claim 1, wherein the process is controlled so that the nitrogen content in the urea granules is at least 46% by weight.

11. The process according to claim 1, wherein gallic acid and/or methylthioninium chloride are introduced in the granulation process in the form of a dispersion in an aqueous urea solution.

12. The process according to claim 11, wherein the methylthioninium chloride dispersion has a concentration of 15% to 30% by weight and/or the gallic acid dispersion has a concentration of 20% to 35% by weight.

13. A granulated urea comprising at least one of methylthioninium chloride and gallic acid as an additive, wherein said granulated urea is obtained by the process of granulation of urea according to claim 1.

14. The granulated urea according to claim 13, comprising:
methylthioninium chloride in an amount of 0.12 to 10 grams of methylthioninium chloride per kg of granulated urea, preferably 0.5 to 5.0 g/kg and more preferably 0.8 to 1.5 g/kg, and/or
gallic acid in an amount of 0.2 to 10 grams of gallic acid per kg of granulated urea, preferably 0.5 to 5.0 g/kg and more preferably 1.0 to 3.0 g/kg.

15. The granulated urea according to claim 13, having a multi-layered structure comprising a core, a first layer around the core containing methylthioninium chloride as an additive and a second layer around the first layer containing gallic acid as an additive.

16. The granulated urea according to claim 15, wherein the methylthioninium chloride is contained predominantly or exclusively in said first layer, and/or wherein the gallic acid is contained predominantly or exclusively in said second layer of the granules.

17. (canceled)
